(19) United States
(12) Patent Application Publication
(10) Pub. No.: US 2014/0229483 A1
(43) Pub. Date: Aug. 14, 2014

(54) METHOD AND SYSTEM FOR ADVANCED LEARNING EXPERIENCE (ALEX)

(71) Applicant: HPT Development, LLC, Austin, TX (US)

(72) Inventors: Manu Rehani, Portland, OR (US); Warrren L. Wolf, Austin, TX (US)

(73) Assignee: HPT Development, LLC, Austin, TX (US)

(21) Appl. No.: 14/179,147

(22) Filed: Feb. 12, 2014

Related U.S. Application Data
(60) Provisional application No. 61/763,637, filed on Feb. 12, 2013.

(51) Int. Cl. G06F 17/30

(52) U.S. Cl. CPC G06F 17/30707
USPC 707/737

(57) ABSTRACT

To assist student learning, an educational goal of the student can be identified and validated by a teacher. Educational landmarks that need to be reached can be identified. Educational materials relating to the educational landmarks can be processed to identify language patterns, which can then be used to classify the student and teacher into stages of the learning process and guide the student and teacher through the stages of the learning process.

### RELATED APPLICATION DATA

This application claims the benefit of U.S. Provisional Patent Application No. 61/763,637, titled “A Method and System for Advanced Learning Experience (ALEX)”, filed Feb. 12, 2013, which is incorporated by reference herein for all purposes.

### FIELD

This invention pertains to ways of learning, and more particularly to improved ways for learning.

### BACKGROUND

Many conventional learning methods and systems are generally based on a four step process. First, the student's abilities are assessed through some form of personalized or standardized test. Second, the results of this assessment are used to define the limits and possibilities of a functional approach to learning. Third, the functionalities of these approaches define the limits and possibilities of the direction of learning. And fourth, the set of directions define the limits and possibilities of outcomes of the learning process. In other words, these approaches have a “learning as a structural framework” point of view and assume a given shape (the student's abilities in this case). This shape determines and narrows down the range of possible functions (learning and teaching approaches available in this case), which in turn determines and narrows down the range of possible directions (subjects, disciplines, topics, skills, etc.) that the student can pursue in this case. Ultimately, this shape affects the range of possible outcomes (jobs, vocations, certificates etc.) available to the student in this case. For example, a student whose linguistic skills do not test well could effectively be blocked from becoming a writer or a poet, even though these professions might be the student's lifelong dream.

A need remains for a way to improve the learning process, that addresses these and other problems associated with the prior art.

### BRIEF DESCRIPTION OF THE DRAWINGS

FIG. 1 shows a how embodiments of the invention can be used to analyze educational materials.

FIG. 2 shows a computer system that can assist in improving the learning experience, according to an embodiment of the invention.

FIGS. 3A-3B show a flowchart of a procedure for improving the learning experience, according to an embodiment of the invention.

### DETAILED DESCRIPTION

There are many drawbacks of conventional approaches to learning. As noted above, conventional approaches to learning sequentially narrow down the learning experience and possible results based on an assessment that might or might not be relevant. The conventional approaches are also deterministic in their approach. The “learning as a structural framework” point of view also leads to making learning sequences that resemble assembly lines in which students of certain qualities are put in at one end and ‘trained and capable’ people come out the other end with little or no variation. Finally, the behavioral results are confused in face of assumed illiteracy at the start of the learning sequence, a numb compliance to the approach, a regimented lethargy when it comes to choosing subjects, disciplines, skills etc. and a self-centered or narcissistic view of the outcome.

Embodiments of the invention can avoid the drawbacks of conventional learning approaches by taking a “learning as an evolving process” point of view. Embodiments of the invention can include a looped system that starts with the student identifying the desired outcomes and the teacher validating those outcomes. Then the desired directions to developing the functional skills can be chosen, the skills can be learned, and the structure or stability to put those skills into practice can be acquired. These four stages are the inverse of the conventional sequence discussed earlier and can loop into another cyclical stage such that the student and learning environment keep evolving. Embodiments of the invention can start with an unlimited yet self-determined set of outcomes and provide a process to grow into the relevant structure for those outcomes in a flexible manner.

For each of the four stages identified above, there is a specific type of language. An analysis of the language of educational materials (the conversations, discussions, presentations, subject matter, tests, etc.) can be used to determine in which stage the student and teacher are vested and how the process is progressing.

In some embodiments of the invention, the process goes through the following steps:
1) Read in all educational materials for a given course or curriculum.
2) Count the occurrences of each language pattern in each language structure (sentences, phrases etc.) and use it to compute the proportion of each language type in the educational materials through a scoring process. The proportion of each language type in the educational materials can yield a language profile for each of the educational materials indicating the predominant language type.
3) The language profiles of existing educational materials can be analyzed and compiled into an assessment report. The report can show the investment in each stage of the learning process.

Embodiments of the invention can also be used in another mode to guide the learning process. Any new educational materials can be made with the language patterns desirable for the appropriate stage of the learning experience and then put through the system to get a guide on changes to make. The guide can be used as feedback to adjust the educational materials to get the appropriate language for each stage.

The various tables below show information about the various stages of the learning process, according to embodiments of the invention. Table 1 shows the four stages of the learning process, and labels for the associated language types for the student and teacher. Table 2 shows languages patterns that are characteristic of each language type. Table 3 shows the investment in each stage of the learning process calculated from the language type.

TABLE 1

| ALEX Stage: | Student Language Type: | Teacher Language Type: |
|---|---|---|
| 1) Understanding | Student-Understanding | Teacher-Understanding |
| 2) Excitement | Student-Excitement | Teacher-Excitement |
| 3) Flexibility | Student-Flexibility | Teacher-Flexibility |
| 4) Recognition | Student-Recognition | Teacher-Recognition |

TABLE 2

| | | Language patterns characteristic of the |
|---|---|---|
| Language type: | | language type: |
| 1) | Student- | Articles like: a, an, the, etc. |
| | Understanding | |
| 2) | Teacher- | Negations and Validations like: no, not |
| | Understanding | never, good, yes, always, etc. |
| 3) | Student-Excitement | Adverbs like: very, really, etc. |
| 4) | Teacher-Excitement | Pronouns like: I, he, she, it, they, etc. |
| 5) | Student-Flexibility | Quantifiers like: most, few, many, most, etc. |
| 6) | Teacher-Flexibility | Prepositions like: with, in, for, etc. |
| 7) | Student-Recognition | Auxiliary Verbs like: don't, have, is, etc. |
| 8) | Teacher-Recognition | Conjunctions like: because, and, but, etc. |

TABLE 3

| Language type: | | Stage in learning process: |
|---|---|---|
| 1) | Student- | A) Average investment in Understanding |
| | Understanding | |
| 2) | Teacher- | |
| | Understanding | |
| 3) | Student-Excitement | B) Average investment in Excitement |
| 4) | Teacher-Excitement | |
| 5) | Student-Flexibility | C) Average investment in Flexibility |
| 6) | Teacher-Flexibility | |
| 7) | Student-Recognition | D) Average investment in Recognition |
| 8) | Teacher-Recognition | |

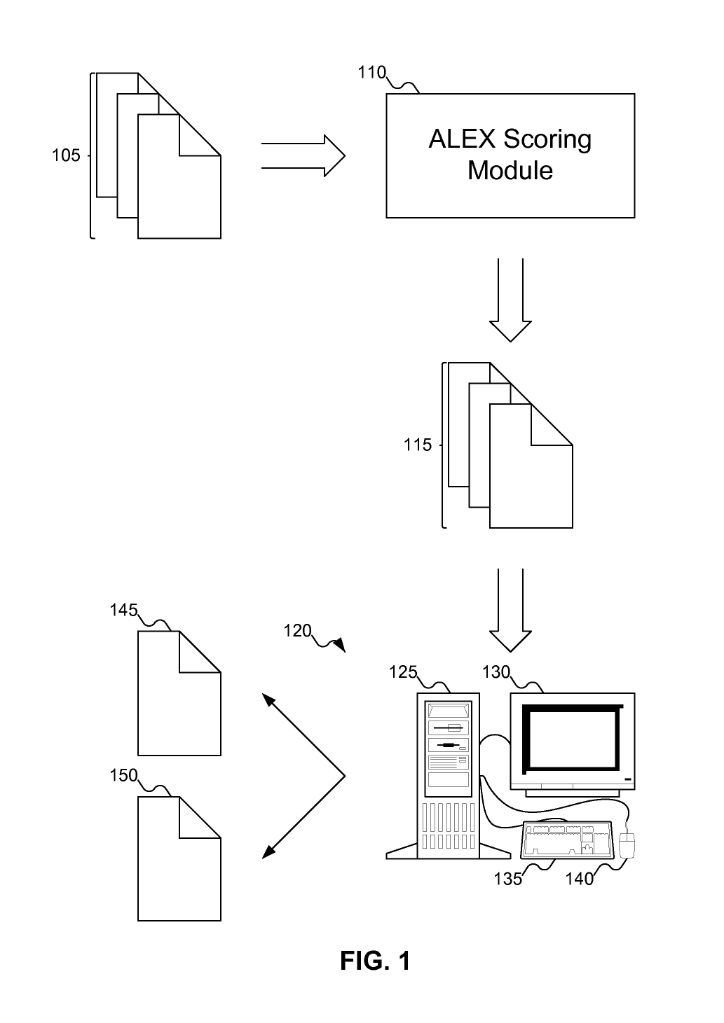

FIG. 1 shows a how embodiments of the invention can be used to analyze educational materials. In FIG. 1, educational materials 105 are provided to scoring module 110. As discussed above, scoring module 110 can score educational materials 105 to determine language profile 115. As discussed above, in one embodiment of the invention, scoring module 110 can operate by counting the number of occurrences of each language pattern, and determine the stage of the educational materials as the most frequently occurring language pattern. In other embodiments of the invention, other language analysis systems can be used, and/or other approaches can be used to determine the stage of educational materials 105. Language profile 115 can be produced in isolation, or it can include educational materials 105 as part of language profile 115.

Language profile 115 can then be fed into computer system 120. Computer system 120 conventionally includes a computer 125, a monitor 130, a keyboard 135, and a mouse 140. Optional equipment not shown in FIG. 1 can include a printer and other input/output devices. Also not shown in FIG. 1 are the conventional internal components of computer system 120: e.g., a central processing unit, memory, file system, etc. A person of ordinary skill in the art will recognize that while FIG. 1 shows a computer system, computer system 120 can readily be replaced be any other system that can support language analysis of educational materials 105 according to embodiments of the invention. For example, computer system 120 could be replaced by an appropriately configured server or mobile device, among other possibilities. Computer system 120 can then process language materials 115 to produce either assessment report 145 or learning guide 150, depending on the mode of operation of the embodiment of the invention.

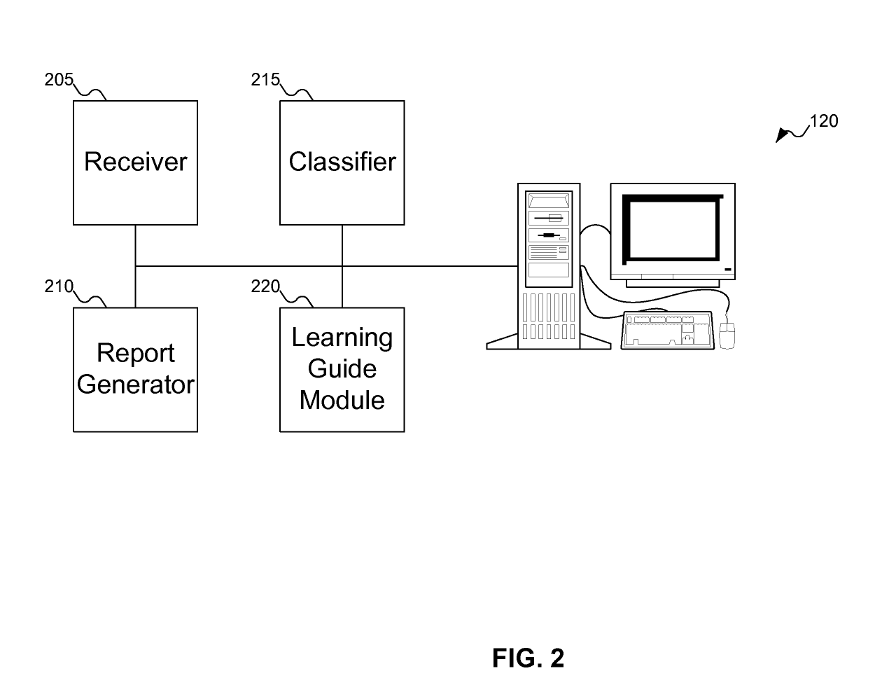

FIG. 2 shows a computer system that can assist in improving the learning experience, according to an embodiment of the invention. In FIG. 2, computer system 120 is shown as including various modules: receiver 205, report generator 210, classifier 215, and learning guide module 220. Receiver 205 can be used to receive information into computer system 120: for example, receiver 120 can be used to receive the educational materials for analysis. Report generator 210 can be used to generate an assessment report. Classifier 215 can be used to classify the student and teacher each into one of the four stages shown in Table 2. Learning guide module 220 can be used to guide the student and teacher back into sync, if it turns out that they are in different stages of the learning process. As discussed above, embodiments of the invention can repeat the analysis of educational materials after new educational materials are received (e.g., via receiver 205). This new analysis can result in the changing the determined stage of the student and/or teacher.

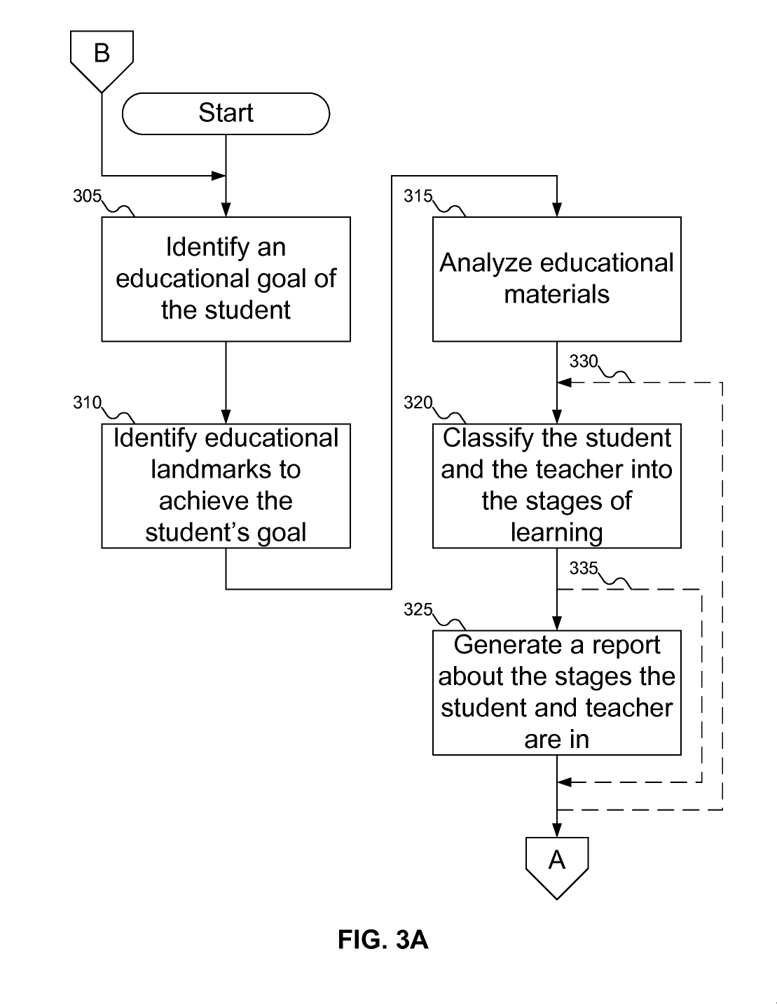

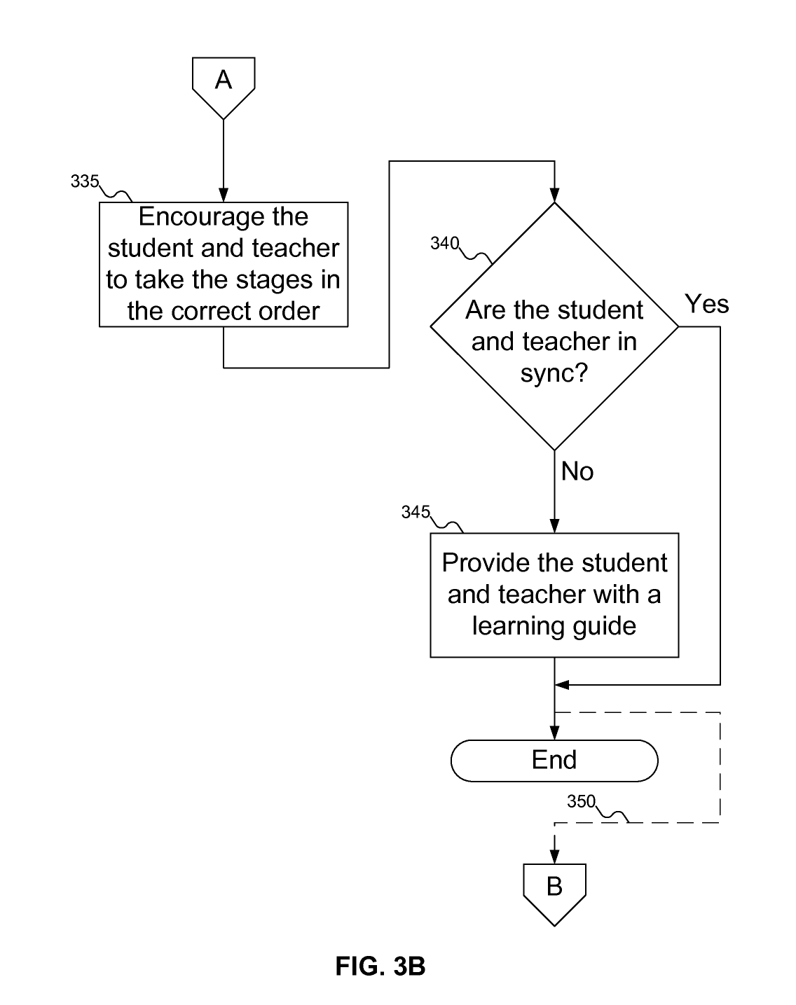

FIGS. 3A-3B show a flowchart of a procedure for improving the learning experience, according to an embodiment of the invention. In FIG. 3A, at block 305, an educational goal of the student is identified. At block 310, educational landmarks that need to be reached to achieve the goal are identified. At block 315, the system can received educational materials and analyze them. At block 320, the student and teacher can be classified into the stages of learning. At block 325, the system can generate a report about the stages the student and teacher are in. As shown by dashed arrow 330, blocks 320 and 325 can be repeated as needed. Also, as shown by dashed arrow 325, block 325 can be omitted.

At block 335 (FIG. 3B), the system can encourage the student and teacher to take the stages of the learning process in the correct order. At block 340, the system can determine if the student and teacher are in sync. If not, then at block 345, the system can provide the student and teacher with a learning guide to get them back in sync. As shown by dashed arrow 350, the overall process can be repeated as needed (for example, once the student has achieved thee educational goal).

Although the above description implies a specific order for steps in the algorithms, and suggests that certain blocks are required or optional, a persons killed in the art will recognize ways in which the sequence of blocks can be reordered without loss of function. In addition, a person skilled in the art will recognize that various blocks can be omitted without loss of functionality, whether or not specifically identified as optional.

The following discussion is intended to provide a brief, general description of a suitable machine in which certain aspects of the invention may be implemented. Typically, the machine includes a system bus to which is attached processors, memory, e.g., random access memory (RAM), read-only memory (ROM), or other state preserving medium, storage devices, a video interface, and input/output interface ports. The machine may be controlled, at least in part, by input from conventional input devices, such as keyboards, mice, etc., as well as by directives received from another machine, interaction with a virtual reality (VR) environment, biometric feedback, or other input signal. As used herein, the term “machine” is intended to broadly encompass a single machine, or a system of communicatively coupled machines or devices operating together. Exemplary machines include computing devices such as personal computers, workstations, servers, portable computers, handheld devices, telephones, tablets, etc., as well as transportation devices, such as private or public transportation, e.g., automobiles, trains, cabs, etc.

The machine may include embedded controllers, such as programmable or non-programmable logic devices or arrays, Application Specific Integrated Circuits, embedded computers, smart cards, and the like. The machine may utilize one or more connections to one or more remote machines, such as through a network interface, modem, or other communicative coupling. Machines may be interconnected by way of a physical and/or logical network, such as an intranet, the Internet, local area networks, wide area networks, etc. One skilled in the art will appreciated that network communication may utilize various wired and/or wireless short range or long range carriers and protocols, including radio frequency (RF), satellite, microwave, Institute of Electrical and Electronics Engineers (IEEE) 802.11, Bluetooth, optical, infrared, cable, laser, etc.

The invention may be described by reference to or in conjunction with associated data including functions, procedures, data structures, application programs, etc. which when accessed by a machine results in the machine performing tasks or defining abstract data types or low-level hardware contexts. Such embodiments may also be referred to as program products. Associated data may be stored in, for example, the volatile and/or non-volatile memory, e.g., RAM, ROM, etc., or in other storage devices and their associated storage media, including hard-drives, floppy-disks, optical storage, tapes, flash memory, memory sticks, digital video disks, biological storage, etc. Associated data may also be used in conjunction with communications media such antennas, wires, optical fibers, microwaves, radio waves, and other electromagnetic or optical carriers. Associated data may be delivered over transmission environments, including physical and/or logical networks, in the form of packets, serial data, parallel data, propagated signals, etc., and may be used in a compressed or encrypted format. Associated data may be used in a distributed environment, and stored locally and/or remotely for machine access.

Having described and illustrated the principles of the invention with reference to illustrated embodiments, it will be recognized that the illustrated embodiments may be modified in arrangement and detail without departing from such principles. And, though the foregoing discussion has focused on particular embodiments, other configurations are contemplated. In particular, even though expressions such as “illustrated embodiment” or the like are used herein, these phrases are meant to generally reference embodiment possibilities, and are not intended to limit the invention to particular embodiment configurations. As used herein, these terms may reference the same or different embodiments that are combinable into other embodiments. Further, the various embodiments may be combined in any manner desired, to produce combinations not specifically discussed herein.

Consequently, in view of the wide variety of permutations to the embodiments described herein, this detailed description and accompanying material is intended to be illustrative only, and should not be taken as limiting the scope of the invention. What is claimed as the invention, therefore, is all such modifications as may come within the scope and spirit of the following claims and equivalents thereto.

1. A system, comprising:
a computer;
a receiver on the computer to receive educational materials; and
a classifier to classify a student and a teacher into one of four stages based on educational materials.

2. A system according to claim 1, further comprising a report generator to generate a report based on the classifier.

3. A system according to claim 1, further comprising a learning guide module to get the student and the teacher back in sync if they are in different stages.

4. A system according to claim 1, further comprising a scoring module to score the educational materials.

5. A method, comprising:
identifying an educational goal for a student;
identifying what the student needs to learn from a teacher to achieve the educational goal; and
using a computer, classifying the student and teacher each into one of four stages.

6. A method according to claim 5, further comprising repeating the steps upon completion of the educational goal by the student.

7. A method according to claim 5, further comprising using the computer, encouraging the student and teacher to take the stages in a correct order.

8. A method according to claim 5, wherein classifying the student and teacher each into one of four stages includes repeatedly classifying the student and teacher each into one of four stages over time.

9. A method according to claim 5, wherein classifying the student and teacher each into one of four stages includes using the computer, analyzing educational materials.

10. A method according to claim 5, further comprising providing the student and teacher with a learning guide if the student and teacher are not in corresponding stages.

11. A method according to claim 5, further comprising generating a report about what stages the student and teacher are in.

12. An article, comprising a non-transitory storage medium, said non-transitory storage medium having stored thereon instructions that, when executed by a processor, result in:
identifying an educational goal for a student;
identifying what the student needs to learn from a teacher to achieve the educational goal; and
using a computer, classifying the student and teacher each into one of four stages.

13. A method according to claim 12, said non-transitory storage medium having stored thereon further instructions that, when executed by the processor, result in repeating the steps upon completion of the educational goal by the student.

14. A method according to claim 12, said non-transitory storage medium having stored thereon further instructions that, when executed by the processor, result in using the computer, encouraging the student and teacher to take the stages in a correct order.

15. A method according to claim 12, wherein classifying the student and teacher each into one of four stages includes repeatedly classifying the student and teacher each into one of four stages over time.

16. A method according to claim 12, wherein classifying the student and teacher each into one of four stages includes using the computer, analyzing educational materials.

17. A method according to claim 12, said non-transitory storage medium having stored thereon further instructions that, when executed by the processor, result in providing the student and teacher with a learning guide if the student and teacher are not in corresponding stages.

18. A method according to claim 12, said non-transitory storage medium having stored thereon further instructions that, when executed by the processor, result in generating a report about what stages the student and teacher are in.
